(19) United States
(12) Patent Application Publication
(10) Pub. No.: US 2005/0063404 A1
(43) Pub. Date: Mar. 24, 2005

(54) Consumption based bandwidth arbitration

(76) Inventors: Jeyhan Karaoguz, Irvine, CA (US); James D. Bennett, San Clemente, CA (US)

Correspondence Address: MCANDREWS HELD & MALLOY, LTD, 500 WEST MADISON STREET, SUITE 3400, CHICAGO, IL, 60661, US

(21) Appl. No.: 10/875,893

(22) Filed: Jun. 24, 2004

Related U.S. Application Data
(60) Provisional application No. 60/505,013, filed on Sep. 22, 2003.

(51) Int. Cl. H04J 3/12

(52) U.S. Cl. 370/418

(57) ABSTRACT

A system and method for consumption-based bandwidth arbitration in a dynamic information consumption environment. Various aspects of the present invention provide apparatus, structure and method steps for allocating common communication bandwidth between an information presentation system and various information source devices. Communication between an information presentation system and the various information source devices is provided. A plurality of information source devices available in the dynamic information consumption environment may be detected, and a user may select various information source devices. Information received from various information source devices is presented to a user in human-perceivable form, and user consumption of the information presented to the user may be tracked. Portions of common communication bandwidth for communication between the various information source devices and an information presentation system are allocated based on the user's information consumption.

### CROSS-REFERENCE TO RELATED APPLICATIONS/INCORPORATION BY REFERENCE

This patent application is related to and claims priority from provisional patent application Ser. No. 60/505,013, filed Sep. 22, 2003, and titled “CONSUMPTION BASED BANDWIDTH ARBITRATION” (Attorney Docket No. 15208US01), the contents of which are hereby incorporated herein by reference in their entirety. This patent application is related to U.S. patent application Ser. No. ______, filed concurrently with the present application, and titled “CONSUMPTION BASED SOURCE THROTTLING” (Attorney Docket No. 15209US02).

### FEDERALLY SPONSORED RESEARCH OR DEVELOPMENT

[Not Applicable]

### SEQUENCE LISTING

[Not Applicable]

### MICROFICHE/COPYRIGHT REFERENCE

[Not Applicable]

### BACKGROUND OF THE INVENTION

In a dynamic network environment, communication bandwidth resources may be limited and the demand for such resources high. For example, a user output system that provides information to a user in human-perceivable form may have a fixed amount of communication bandwidth that the system may utilize to communicate with a variety of information source devices. Each of the information source devices may attempt to communicate information with the user output system, thereby utilizing respective portions of the fixed amount of communication bandwidth. The information source devices may compete for and utilize respective portions of the fixed amount of communication bandwidth whether or not the user is currently consuming the source devices' respective information using the system.

Utilizing portions of the fixed amount of communication bandwidth for communicating information that the user is not currently consuming is generally wasteful of the communication bandwidth. Such unnecessary utilization of the limited amount of communication bandwidth may result in a deficiency of the available communication bandwidth that the system may utilize to provide the desired information to the user. Such unnecessary utilization of communication bandwidth may result, for example, in the user not being able to consume the information that the user desires or not being able to consume the information at the level of quality that the user desires.

Accordingly, a system and method that arbitrates and allocates portions of communication bandwidth to various information source devices based on the user's current information consumption environment is desirable.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and method are provided for consumption-based bandwidth arbitration in a dynamic information consumption environment. Various aspects of the present invention provide apparatus structure and method steps for allocating common communication bandwidth between an information presentation system and various information source devices.

Various aspects of the present invention may provide communication between an information presentation system and the various information source devices. Such communication may occur, for example, over a common communication band. A plurality of information source devices available in the dynamic information consumption environment may be detected. Such detection may be performed, for example, by periodically beaconing and/or scanning various communication media in the environment to determine the existence and availability of information source devices.

Various aspects of the present invention may provide for user selection of various information source devices. Such selection may occur, for example, by the user selecting graphical or textual indicia on a display device. Information received from information source devices may be presented to a user in human-perceivable form. Such information presentation may include, for example, video display and audio presentation. User consumption of information presented to the user may be tracked. For example, display window characteristics or audio consumption quality may be monitored.

Various aspects of the present invention may allocate portions of common communication bandwidth for communication between the various information source devices and the information presentation system based on the user's information consumption. Such allocation may include, for example, allocating relatively large portions of a common communication band to information source devices communicating information that the user is currently consuming and allocating relatively small portions of the common communication band to information source devices that are not currently providing information the user is interested in.

These and other advantages, aspects and novel features of the present invention, as well as details of illustrative aspects thereof, will be more fully understood from the following description and drawings.

### BRIEF DESCRIPTION OF SEVERAL VIEWS OF THE DRAWINGS

FIG. 1 is a diagram illustrating a dynamic information consumption environment in accordance with various aspects of the present invention.

FIG. 2 is a diagram illustrating an information consumption environment incorporating consumption-based bandwidth arbitration in accordance with various aspects of the present invention.

FIG. 3 is a flow diagram illustrating a method incorporating consumption-based bandwidth arbitration in accordance with various aspects of the present invention.

FIG. 4 is a diagram illustrating a dynamic information consumption environment in accordance with various aspects of the present invention.

FIG. 5 is a diagram illustrating an exemplary information consumption environment in accordance with various aspects of the present invention.

FIG. 6 is a diagram illustrating an exemplary dynamic audio information consumption environment in accordance with various aspects of the present invention.

### DETAILED DESCRIPTION OF THE INVENTION

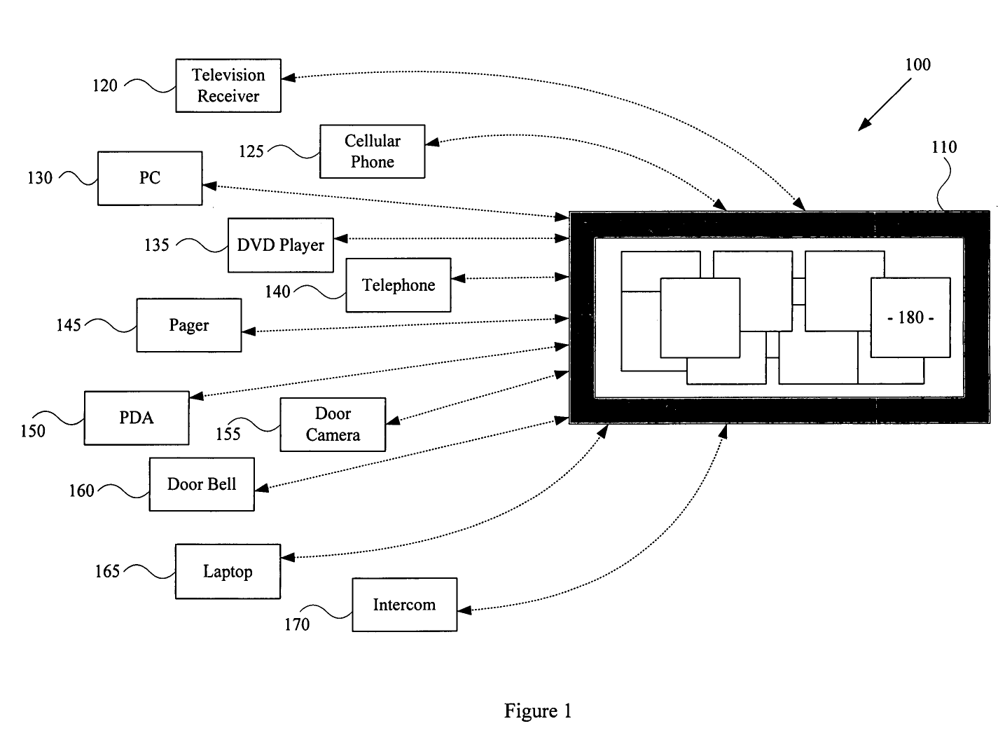

FIG. 1 is a diagram illustrating a dynamic information consumption environment 100 in accordance with various aspects of the present invention. The exemplary information consumption environment 100 includes an information presentation system 110. The information presentation system 110 may include, for example, an audio/visual display system, an audio presentation system, or other user output system that presents information to a user in human-perceivable form for consumption.

The information consumption environment 100 also includes a plurality of information source devices available within the environment 100 to provide information to the information presentation system 110. Such information source devices may include, for example and without limitation, a television receiver 120, a cellular phone 125, a personal computing system 130, a Digital Video Disk (DVD) player 135, a telephone system 140, a pager 145, a Personal Digital Assistant (PDA) 150, a door camera 155, a door bell 160, a laptop computer 165 and an intercom system 170. The environment 100 may also be referred to herein as a “network.”

Each of the information source devices may be communicating with or attempting to establish communications with the information presentation system 110. The information presentation system 110 may, for example, have windows 180 (or screens) for providing visual information for user consumption. The information presentation system 110 may also, for example, have audio components for providing audio information for user consumption. The windows 180 may display information from various information source devices. For example, various respective windows 180 may provide visual information to the user originating from the television receiver 120, personal computing system 130, PDA 150 and door camera 155.

The information source devices in the information consumption environment 100 may be capable of providing more information simultaneously to the information presentation system 110 than a user can consume, or desires to consume. Also, the information source devices in the environment 100 may be capable of providing more information simultaneously to the information presentation system 110 than the information presentation system 110 can effectively present to the user. Further, the information source devices in the environment 100 may also be capable of communicating more information to the information presentation system 110 than the available communication bandwidth between the information source devices and the information presentation system 110 can carry. Accordingly, intelligently managing such communications and communication resources is desirable.

For example, the information source devices may communicate information with the information presentation system 110 using one or more wireless standards, such as the Bluetooth, IEEE 802.11, or Ultra Wide Band (UWB) protocols. Such wireless standards have limited amounts of communication bandwidth, which can carry limited amounts of information. In such an exemplary wireless environment, the information source devices may all communicate information with the information presentation system 110 using a common communication band.

Various information source devices may communicate information or attempt to communicate information to the information presentation system 110 regardless of whether the user is interested in consuming their respective information. In such a situation, limited communication bandwidth and other communication resources may be wasted by communicating information in which the user has no present interest or a reduced present interest. Such unnecessarily utilized communication bandwidth and other communication resources may interfere with the user's consumption of desired information.

For example, a user may initially establish an information consumption environment where the user is consuming information from the DVD player 135, door camera 155 and a PDA 150 using the information presentation system 110. The user may then desire to momentarily consume information from the television receiver 120 with a higher priority than the DVD player 135. If, for example, there is insufficient common communication bandwidth with which to adequately communicate information from the television receiver 120 and DVD player 135 to the information presentation system 110 simultaneously, the information presentation system 110 may re-allocate portions of the common communication bandwidth from the DVD player 135 to the television receiver 120.

As a further example, the user may reduce the size of a display window on the information presentation system 110 on which the user is consuming information from the DVD player 135. The information presentation system 110 may detect this change in consumption, determine that the DVD player 135 is communicating information to the audio/visual display system 110 at a rate and resolution that the user is no longer utilizing, and reduce the amount of common communication bandwidth allocated to the DVD player 135 communications based on this new pattern of user consumption.

As a still further example, the user may then reduce the display window on which the user is consuming information from the DVD player 135 to an icon. The information presentation system 110 may detect this change in consumption, determine that the DVD player 135 is communicating information to the information presentation system 110 that the user is not currently consuming, and reduce the amount of common communication bandwidth allocated to the DVD player 135 to some minimum level, for example, to maintain control and access links between the information presentation system 110 and the DVD player 135. The information presentation system 110 may then re-allocate this newly available bandwidth to communication links between the information presentation system 110 and other information source devices that are providing information that the user is currently consuming.

As another illustrative example, a user may initially establish an information consumption environment where the user is consuming information on the information presentation system 110 from the television receiver 120 and PDA 150 when the doorbell 160 rings. In response to the ringing doorbell 160, aspects of the information presentation system 110 may automatically allocate portions of the common communication bandwidth to the door camera 155 and create an associated viewing window on a display of the information presentation system 110. Depending on current communication bandwidth usage, the information presentation system 110 may also, for example, temporarily re-allocate a portion of common communication bandwidth from another information source device to the door camera 155 communications to serve this immediate need.

Note that the information presentation system 110 including an audio/visual display system is but one example of a information presentation system that may provide human-perceivable information to a user for consumption. Accordingly, the scope of various aspects of the present invention should, by no means, be limited by characteristics of an audio/visual display system. In addition, though portions of the following discussion may generally refer to a wireless communication environment, which provides a convenient example of a communication environment with finite common communication bandwidth, the scope of various aspects of the present invention should, by no means, be limited by characteristics of a wireless communication environment. For example, and without limitation, information source devices may communicate with an information presentation system using wired links, wireless (or RF) links, tethered optical links, and non-tethered optical links.

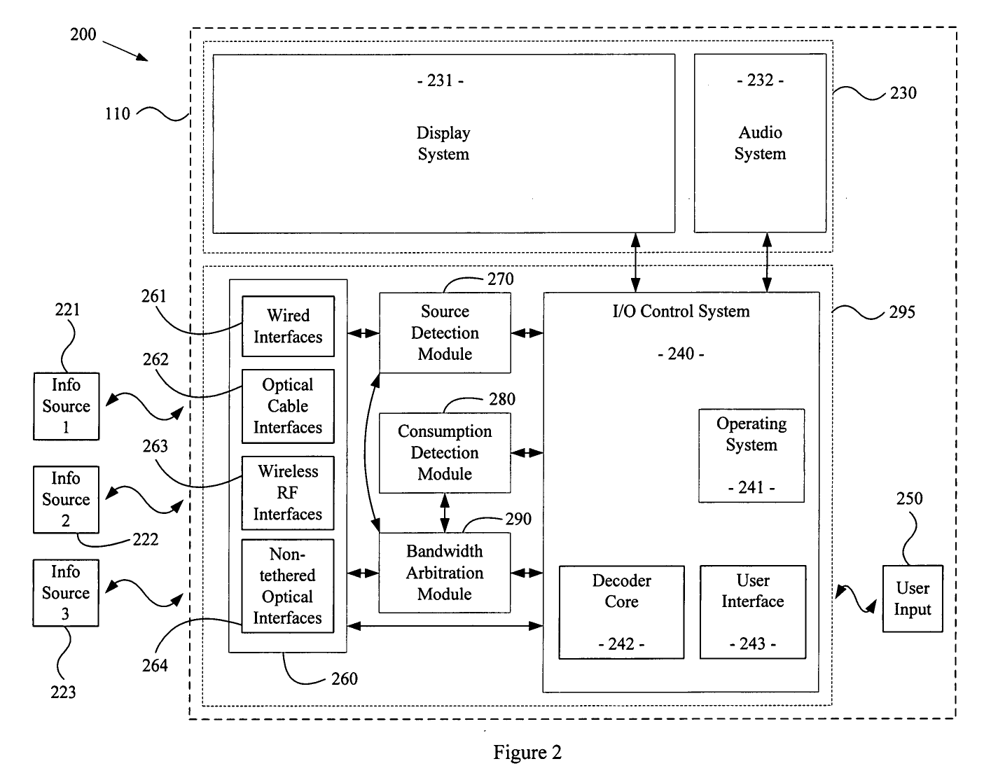

FIG. 2 is a diagram illustrating an exemplary information consumption environment 200 incorporating consumption-based bandwidth arbitration in accordance with various aspects of the present invention. The information consumption environment 200 shows a more detailed illustration of the exemplary information presentation system 110 of FIG. 1, for example, and also shows a plurality of exemplary information source devices 221-223. The exemplary information source devices 221-223 may, for example, be similar to the various information source devices illustrated in FIG. 1.

The information presentation system 110 includes an information output system 230, an I/O control system 240 and a user input system 250. The information presentation system 110 also includes a communication module 260, a source detection module 270, a consumption detection module 280 and a bandwidth arbitration module 290. The exemplary I/O control system 240 includes an operating system module 241, decoder core module 242 and a user interface module 243. The exemplary communication module 260 includes, for example, various communication interface modules, including a wired interface module 261, an optical cable interface module 262, a wireless RF interface module 263 and a non-tethered optical interface module 264.

The information output system 230 generally includes apparatus to present information to a user for consumption in human-perceivable form. The exemplary information output system 230 includes a display system 231 and an audio system 232. The display system 231 and audio system 232 are aspects of an exemplary information output system 230, and accordingly, should by no means limit the scope of various aspects of the present invention to particular user output devices. For example, the information output system 230 may alternatively include any of a variety of devices that present information to a user for consumption in human-perceivable form.

The communication module 260 generally includes apparatus to provide a communication interface between the information presentation system 110 and various information source devices. The exemplary communication module 260 shown in FIG. 2 includes a wired interface module 261, optical cable interface module 262, wireless RF interface module 263 and non-tethered optical interface module 264.

The wired interface module 261 may provide a communication interface for information source devices using wired communication links. The optical cable interface module 262 may provide a communication interface for information source devices using optical cable communication links. The wireless RF interface module 263 may provide a communication interface for information source devices using wireless RF communication links, such as, for example, wireless links based on Bluetooth, IEEE 802.11, and Ultra Wide Band (UWB). The non-tethered optical interface module 264 may provide a communication interface for information source devices using non-tethered optical communication links, such as, for example, infrared or ultraviolet communication links. The various exemplary interface modules 261-264 illustrated in FIG. 2 are exemplary interface modules, and should, by no means, limit the scope of various aspects of the present invention to particular communication link structures, methods or related apparatus.

The source detection module 270 is communicatively coupled to the communication module 260. The source detection module 270 generally detects devices in the information consumption environment 200 that have information available for user consumption. For example, FIG. 2 illustrates three such exemplary information source devices 221-223. As discussed previously, the information source devices 221-223 may include a large variety of information source devices.

The source detection module 270 may, for example, periodically utilize the communication module 260 to perform a network (or environment) scan to detect the existence of information source devices in the information consumption environment 200. For example, in a wireless RF environment, the source detection module 270 may utilize a wireless RF interface module 263 in the communication module 260 to scan Bluetooth, IEEE 802.11 and UWB frequencies to detect information source devices. The source detection module 270 may, for example, cause the transmission of beacons throughout the information consumption environment 200.

The source detection module 270 may, upon detection of such information source devices, handshake with such devices to ascertain the information that the devices have available for user consumption and to determine the communication capabilities of the devices. The source detection module 270 may then communicate information regarding detected information source devices to various system components by generating a signal indicative of such information.

For example, the source detection module 270 may detect the first information source device 221 and determine that the first information source device 221 has recorded audio/visual information available for user consumption and has the capability to communicate such audio/visual information to the information presentation system 110 using either UWB or infrared communication links. The source detection module 270 may then detect the second information source device 222 and determine that the second information source device 222 has door camera video information available for user consumption and has the capability to communicate such door camera video information to the information presentation system 110 using either Bluetooth or UWB communication links. The source detection module 270 may then detect the third information source device 223 and determine that the third information source device 223 has television audio/visual information available for user consumption and has the capability to communicate such television audio/visual information to the information presentation system 110 over UWB, IEEE 802.11 and infrared links.

The source detection module 270 is communicatively coupled to the I/O control system 240. The source detection module 270 may communicate a signal indicative of detected information source devices to the I/O control system 240. The I/O control system 240, which is coupled to the information output system 230, may then output a signal to the information output system 230 that is indicative of the detected information source devices. The information output system 230 may then, based on this signal from the I/O control system 240, present to the user various indicia of the detected information sources.

The I/O control system 240 may, for example, include an operating system module 241 that performs various aspects of this interface between the source detection module 270 and the information output system 230. The operating system module 241 may, for example, receive the signal from the source detection module 270 indicative of detected information source devices and generate a corresponding signal to cause the information output system 230 to generate visual indicia of the detected information source devices. Such visual indicia may include graphical indicia, such as icons, displayed on the display system 231. Such visual indicia may include textual indicia, such as a list in a pull-down menu, displayed on the display system 231. The operating system module 241 may, for example, communicate a signal to the information output system 230 that causes the information output system 230 to output various audio indicia on the audio system 232 corresponding to detected information source devices.

The information presentation system 110 includes a user input system 250. The exemplary user input system 250 illustrated in FIG. 2 may be communicatively coupled to the I/O control system 240. The I/O control system 240 may, for example, include a user interface module 243 communicatively coupled to the user input system 250 to manage communications between the user input system 250 and the I/O control system 240.

A user may, utilizing the user input system 250, control the presentation of information from the various information source devices 221-223 on the information output system 230. The user may perceive various indicia provided to the user by the information presentation system 110 that are representative of detected information source devices and utilize the user input system 250 to select various information source devices from which the user is interested in consuming information. For example, the user may utilize the user input system 250 to control a cursor that the user interface module 243 and operating system module 241 cause the display system 231 to output. The user may manipulate such a cursor to select various indicia of detected information source devices on the display system 231. Alternatively, for example, the user input system 250 may, in conjunction with the user interface module 243 and operating system 241, provide indicia on the user input system 250 that correspond to the various detected information source devices.

The user may also, utilizing the user input system 250, specify to the I/O control system 240 the quality or spatial/temporal resolution level at which the user desires to consume information. For example, the user may utilize the user input system 250 to specify that a first video output window on the display system 231 is one fourth the size of a second video output window on the display system 231. The user may also utilize the user input system 250 to specify to the I/O control system 240, priority levels for various information that the user is consuming. For example, the user may indicate priority level by explicitly giving display windows priority rankings or may indicate priority level by layering various windows.

Generally, the user input system 250, user interface module 243 and operating system 241 may include a wide range of apparatus that provide a user the capability to select between various detected and available information source devices. For example, the user input system 250 may include a mouse, trackball, or thumbwheel. The user input system 250 may have an on-board output device or the user may, for example, utilize aspects of the information output system 230 for user output and feedback. Accordingly, the scope of various aspects of the present invention should, by no means, be limited to particular user input apparatus configurations.

When a user, via the user input system 250, indicates to the information presentation system 110, which information source devices the user is interested in consuming information from, and in some cases the specific information within the desired information source devices that the user is interested in consuming, the I/O control system 240 generates signals that reflect this user input. For example, the I/O control system 240 may utilize such user indications to effect various display changes on the display system 231. The I/O control system 240 may, for example, detect the user maximizing an icon on the display system 231. The I/O control system 240 may also, for example, detect the user changing the size of a window on the display system 231. The I/O control system 240 may also, for example, detect the user changing the window layering on the display system 231. The I/O control system 240 may generally detect user indications indicative of the user's consumption of information on the information presentation system 110 and generate corresponding output signals.

The information presentation system 110 includes a consumption detection module 280 that is communicatively coupled to the I/O control system 240. The consumption detection module 280 may receive signals from the I/O control system 240 indicative of user selection of desired information source devices and information for consumption. The consumption detection module 280 may receive signals from the I/O control system 240 indicative of user modifications to the nature of the information consumption, such as, for example, changes in selected windows, window size and window layering. The consumption detection module 280 may process such signals to track the current state of user information consumption. For example, the consumption detection module 280 may track which information sources the user has iconized and for which information sources the user has opened windows. The consumption detection module 280 may track the size and layering or priority of particular windows in which the user is consuming information. The consumption detection module 280 may generate a signal indicative of the current state of user information consumption and output such a signal to various devices and modules.

The information presentation system 110 includes a bandwidth arbitration module 290. The bandwidth arbitration module 290 may, for example, be communicatively coupled to the consumption detection module 280, the source detection module 270, the communication module 260 and the I/O control system 240. The bandwidth arbitration module 290 may receive the signal indicative of the current state of user information consumption from the consumption detection module 280. The bandwidth arbitration module 290 may process this signal to determine an appropriate communication bandwidth allocation for communications between the information presentation system 110 and the various information source devices 221-223.

For example, the bandwidth arbitration module 290 may process the signal indicative of the current state of user information consumption from the consumption detection module 280 and determine that the user has indicated a desire to consume information from the first information source device 221 at a higher priority level or higher quality level than information from the second information source device 222. In response, the bandwidth arbitration module 290 may de-allocate at least a portion of communication bandwidth formerly allocated to communications with the second information source device 222 and re-allocate that bandwidth to communications with the first information source device 221.

As another example, the bandwidth arbitration module 290 may process the signal indicative of the current state of user information consumption from the consumption detection module 280 and determine that the user has indicated a desire to stop consuming information from the first information source device 221 and begin consuming information from the second information source device 222. The bandwidth arbitration module 290 may de-allocate all or most of the communication bandwidth formerly allocated to communications with the first information source device 221 and re-allocate at least a portion of the de-allocated bandwidth to communications with the second information source device 222. Depending on the nature of the particular communication protocol being utilized to communicate information between the first information source device 221 and the information presentation system 110, the bandwidth arbitration module 290 may force a disassociation between the first information source device 221 to accomplish the bandwidth de-allocation.

The bandwidth arbitration module 290 may still, for example, allocate a relatively small portion of the available communication bandwidth to information source devices not selected by the user. The information presentation system 110 may communicate with such non-selected information source devices to, for example, maintain an active list of available information resources. The information presentation system 110 may also, for example, utilize such communication links to maintain a state of readiness for the non-selected information source devices or to effect low-priority communications with the non-selected devices. Such a state of readiness may be advantageous, for example, by providing for quick response to user information consumption demands while providing a low-power operating mode for the non-selected information source devices, which may have limited power supplies.

The bandwidth arbitration module 290 may generate a signal indicative of a communication bandwidth allocation and communicate this signal to the communication module 260. The communication module 260 may utilize this signal to manage communications with the information source devices 221-223 in accordance with the bandwidth allocation provided by the bandwidth arbitration module 290.

The communication module 260 is communicatively coupled to the I/O control system 240 and may communicate information between the I/O control system 240 and the various information source devices 221-223. Information may arrive from the various information source devices 221-223 encoded in a variety of formats. Accordingly, the I/O control system 240 may include a decoder core module 242. The decoder core module 242 may perform any necessary decoding of information arriving from the information source devices 221-223 through the communication module 260. The decoder core module 242 may then provide the decoded information to the information output system 231 for output to the user.

The decoder core module 242 may contain, for example, capability to decode a large variety of various encoding schemes. For example, and without limitation, the decoder core module 242 may have the capability to decode various video standards, such as SVGA and MPEG standards, and may have the capability to decode various audio standards, such as WAV and MP3. The decoder core module 242 may include a collection of various individual decoder modules or may alternatively include a decoding processor that time-shares between various encoded information streams.

The information presentation system 110 may include various groupings of the system components and modules discussed previously. For example, the information output system 230 may be a stand-alone system, and the communication module 260, source detection module 270, consumption detection module 280, bandwidth arbitration module 290 and I/O control system 240 may reside in a separate physical unit. Such a configuration is illustrated in FIG. 2 by dashed lines 230 and 295. Also for example, all of the above-mentioned components may be housed in a single enclosure. Further, for example, all aspects of the information presentation system 110, apart from various components of the information output system 230 and various components of the user input system 250, may be combined in a single integrated circuit. Additionally, various aspects of the present invention may be performed with dedicated hardware or a processor executing software or firmware instructions. Accordingly, the scope of various aspects of the present invention should, by no means, be limited to particular groupings or arrangements of the various modules, nor to particular implementations of the disclosed functionality.

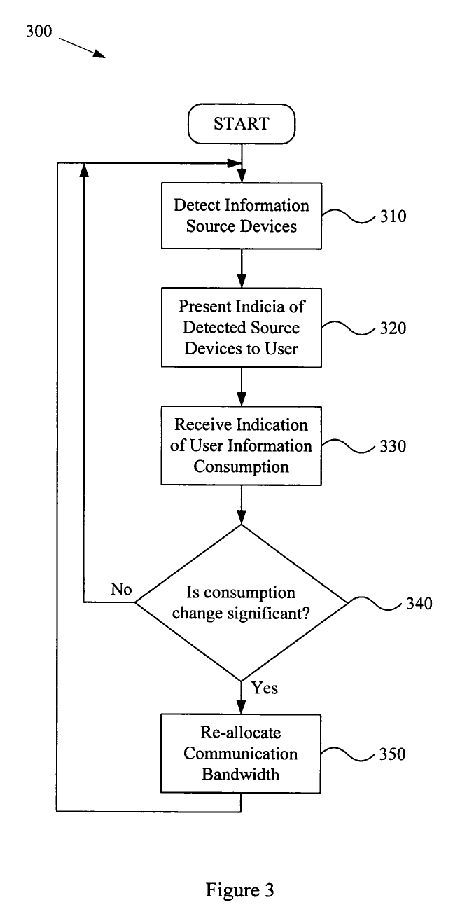

FIG. 3 is a diagram illustrating a method 300 incorporating consumption-based bandwidth arbitration in accordance with various aspects of the present invention. Various aspects of the method 300 may, for example, be implemented using the various components shown in the information consumption environment 200 illustrated in FIG. 2 and discussed previously. The exemplary method 300 generally includes performing consumption-based bandwidth arbitration for communications between various information source devices and a user information presentation system (or “user output system”), such as, for example, an audio/visual display system or audio presentation system.

The method 300 includes detecting information source devices at step 310. Information source devices may include any of a large variety of devices that can provide information to a user for consumption. For example and without limitation, information source devices may include television receivers, personal computers, cellular phones, digital video disk players, pagers, telephones, personal digital assistants, pocket computers, cameras, door bells, laptop computers, intercom systems, radios, portable music players, etc. Also, the information source devices may communicate their respective information over a large variety of communication protocols and standards. For example, the information source devices may communicate information over wireless links, wired links, optical cable links, and non-tethered optical cable links. Accordingly, the scope of various aspects of the present invention should, by no means, be limited to particular types of information source devices or particular communication media or protocols.

Step 310 may include, for example, periodically scanning a network or communication environment to determine what information source devices exist in the network and determine whether the detected information source devices have the capability to communicate their respective information to an information output system. For example, in a wireless environment, step 310 may include transmitting beacons and scanning Bluetooth, IEEE 802.11 and UWB frequencies to detect information source devices. Step 310 may also include, for example, handshaking with various detected information source devices to determine their respective communication capabilities and needs.

The method 300 includes presenting indicia of detected source devices to the user at step 320. Step 320 may include, for example, presenting graphical indicia, such as icons, to the user on a display device. Alternatively, step 320 may include presenting textual or audible indicia to the user indicative of the detected source devices. Such a textual indicia may include, for example, a pull-down menu on a display or an indication on a user remote control device.

Step 320 may also present various indicia to the user based on whether the user is presently consuming information from the corresponding information source device. For example step 320 may present an full-brightness icon to a user to indicate that the information source device is available but that the user is not currently consuming information from the information source device. Step 320 may include presenting a reduced-color or reduced-brightness icon to a user to indicate that the information source device in available and the user is currently consuming information from the information source device. Step 320 may also replace an icon with a window when the user is currently consuming information from the corresponding information source device. Step 320 generally provides indicia of detected information source devices to the user. Accordingly, the scope of various aspects of the present invention should, by no means, be limited to providing specific types of visual indicia to the user.

The method 300 includes receiving indications of user information consumption at step 330. Once the method 300 provides the various indicia of detected information source devices at step 320, the user may select the information or information device that the user desires to consume and may also select the manner in which the user desires to consume the information. Step 330 includes receiving indications of the user information consumption selected by the user.

For example step 330 may include receiving a signal or other indication that the user is currently viewing information from a DVD player and television receiver on a screen and viewing email information from a PDA on the screen. The signal or other indication may indicate that the user has selected an information source device from which to consume information by, for example, selecting a graphical indication or textual indication provided to the user at step 320. The signal or other indication may also indicate that the user has de-selected other available information sources by, for example, reducing respective display windows to icons. The signal or other indication may also indicate that the user is viewing the DVD player information in a large high-resolution display window and television receiver information in a relatively small display window. Additionally, the signal or other indication may also indicate that the user has reprioritized viewing windows by, for example, moving former background windows to the foreground.

Additionally, the received signal or other indication may be automatically generated by, for example, an interrupt routine. For example, the information consumption environment may be configured to automatically present certain information for user consumption. For example, a door bell event may trigger an automatic display of information from a door camera on a video display.

The method 300 further includes determining whether a received indication of user information consumption represents a change in the user's information consumption that is significant enough to warrant a change in bandwidth allocation at step 340. Step 340 may include, for example, analyzing a signal indicative of the user's consumption of information to determine whether a change in bandwidth allocation is necessary. For example, for a slight modification to the size of a viewing window, there may be no significant advantage to re-allocating communication bandwidth. Also, for example, for a reprioritization of viewing windows in an environment where there is no shortage of communication bandwidth, there may be no significant advantage to re-allocating communication bandwidth.

If, at step 340, the method 300 determines that there is no change in the user's information consumption significant enough to warrant a change in communication bandwidth allocation, the method 300 flow returns to step 310. If, however, at step 340, the method 300 determines that there is a significant change in the user's information consumption, then method 300 flow continues to step 350.

Method step 350 may include allocating common communication bandwidth for communications between one or more information source devices and a user information presentation system based on the indications of user information consumption received in step 330. The communication bandwidth may include portions of common communication bandwidth that is shared among information source devices in the communication network. Step 350 may include, for example, allocating, de-allocating and re-allocating portions of common communication bandwidth based on the indications of user information consumption. Such bandwidth arbitration may also include allocating portions of common communication bandwidth based on user-specified priorities for the information source devices. Such bandwidth arbitration may also include determining an appropriate communication protocol to use between the various information source devices and the information presentation system.

For illustrative purposes, and without limitation, consider the following bandwidth arbitration scenario. At step 310, the method 300 detects three information source devices capable of providing information to a user output device (e.g., a DVD player, PDA and laptop computer). At step 320, the method 300 presents indications to the user to inform the user of the detected information source devices. The user indicates that the user desires to consume information from the DVD player and PDA information source devices. The method 300, at step 330, receives an indication of the user's desired information source consumption. At step 340, the method 300 determines that this new information source consumption is different enough from the previous information consumption to warrant bandwidth arbitration, and thus, the method 300 flow proceeds to step 350. At step 350, the method 300 allocates portions of the common communication bandwidth to facilitate communications between a user output device and the DVD player and PDA information source devices. Step 350 may also, for example, allocate relatively small portions of the common communication bandwidth to maintain minimal or low-power communications between the user output device and the information source devices from which the user is not currently consuming information.

Continuing the example, at step 310, the method 300 detects the existence of a television receiver information source device. The method, at step 320, presents an indication to the user that the television receiver is available to provide information to the user for consumption. At step 330, the method 300 receives an indication that the user has specified a desire to consume information from the television receiver on a relatively large window on a display device and has also moved the window that is presenting information from the DVD player to the background and substantially reduced the size of that window. At step 340, the method 300 determines that this new information source consumption configuration is different enough from the previous consumption configuration to warrant bandwidth arbitration. At step 350, the method 300 may de-allocate a portion of the common communication bandwidth formerly allocated to communications with the DVD player, leaving a portion of the common bandwidth formerly allocated to communications with the DVD player for lower bandwidth background communication. Step 350 may then allocate a portion of the common communication bandwidth to facilitate communications between the television receiver and the information presentation system. This allocated common communication bandwidth may include portions of the common communication bandwidth that were de-allocated from the DVD player.

Continuing with the example, the method 300 next receives an indication that the user is no longer consuming information from the PDA information source device. The method 500 execution may then proceed to step 550, which may de-allocate at least a portion of the common communication bandwidth formerly allocated to the PDA and may re-allocate those portions to the DVD player to enhance the background communications between the information presentation system and the DVD player.

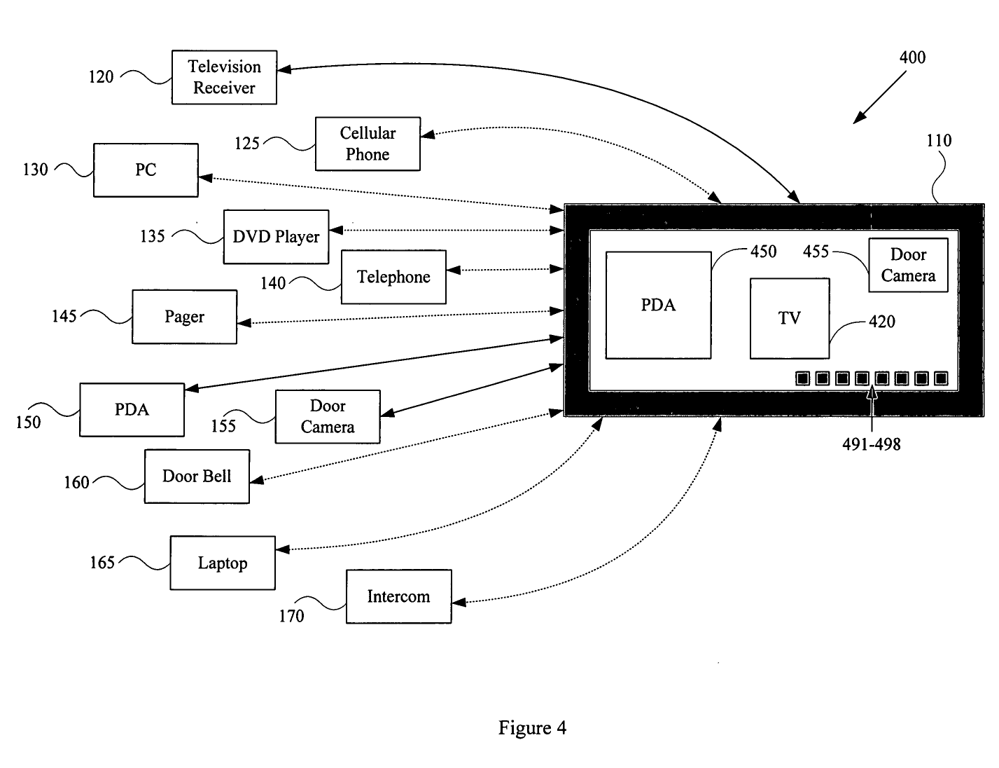

FIG. 4 is a diagram illustrating an exemplary information consumption environment 400 in accordance with various aspects of the present invention. The information consumption environment 400 includes an information presentation system 110, which may, for example, be similar to the information presentation system 110 discussed previously. The illustrative information consumption environment 400 also includes a variety of information source devices, such as those discussed previously.

In the exemplary information consumption environment 400, the user is currently consuming information from the PDA 150, television receiver 120 and door camera 155 in respective windows (450, 420 and 455) on a display in the information presentation system 110. Accordingly, aspects of the information presentation system 110 have allocated respective portions of common communication bandwidth to communications between the information presentation system 110 and the PDA 150, television receiver 120 and door camera 150. Such portions of the common communication bandwidth are generally large enough to accommodate the information flow desired by the user. Communication links utilizing this allocated bandwidth are illustrated in FIG. 4 with solid lines between the information presentation system 110 and the PDA 150, television receiver 120 and door camera 155.

Further, in the illustrative information consumption environment 400, the information presentation system 110 and various information source devices from which the user is not currently consuming information may maintain relatively low bandwidth communication links. For example, the information presentation system 110 may maintain minimal communication links with the cellular phone 125, PC 130, DVD player 135, telephone system 140, pager 145, door bell 160, laptop computer 165 and intercom system 170. The information presentation system 110 may maintain such low bandwidth communication, for example, in preparation for future higher bandwidth communications and to assist in maintaining an accurate list of available information source devices.

For example, the information presentation system 110 may utilize such low-bandwidth communication links to detect information source devices and establish whether the respective information source devices have information available for user consumption. The information presentation system 110 may utilize such low-bandwidth communication links to place various information source devices in a standby mode until the user expresses a desire to consume information from one or more of the information source devices. FIG. 4 illustrates exemplary low-bandwidth communication links, shown as dashed lines, between the information presentation system 110 and various information source devices.

As discussed previously, the information presentation system 110 may present various indications to the user to inform the user of the availability of the respective information source devices detected in the network. In the illustrative information consumption environment 400, the information presentation system 110 displays icons 491-498, which correspond respectively to detected information source devices in the network that have information available for the user to consume. The illustrated icons 491-498 may correspond to the cellular phone 125, PC 130, DVD player 135, telephone 140, pager 145, door bell 160, laptop 165 and intercom 170 information source devices. Alternatively, the information presentation system 110 may present a variety of alternative indications to the user. Such indications may include, for example, a textual list of available information source devices on a pull-down menu or on a remote control unit.

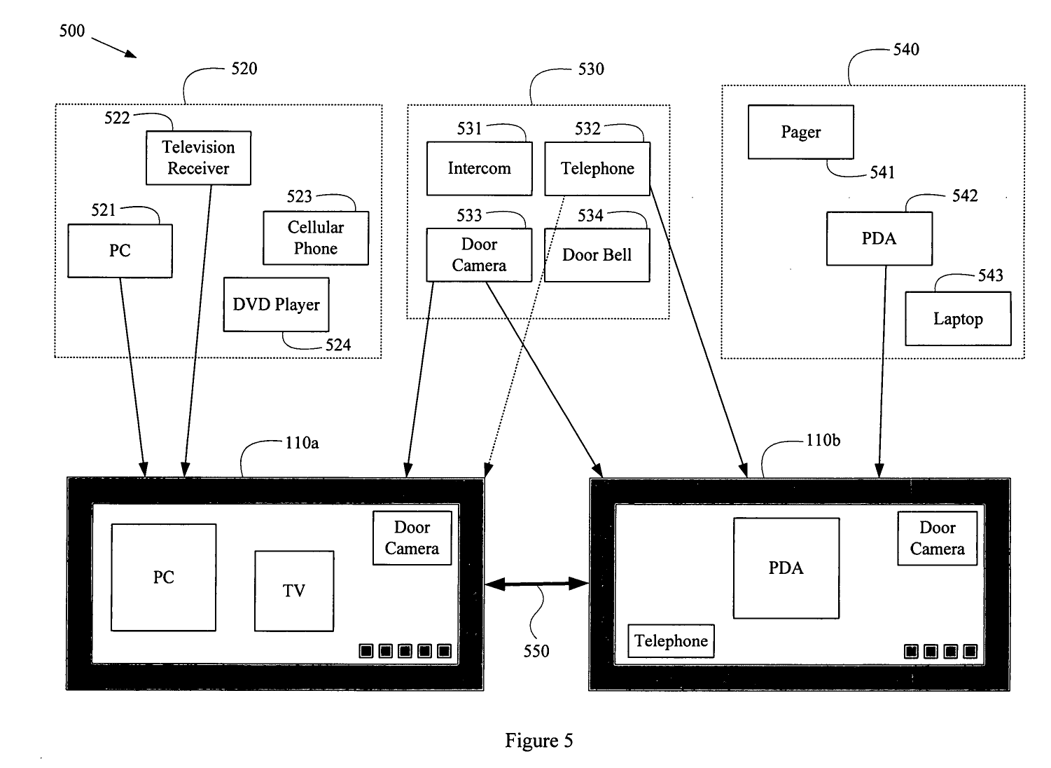

FIG. 5 is a diagram illustrating an exemplary information consumption environment 500 in accordance with various aspects of the present invention. The information consumption environment 500 includes a first information presentation system 110a, which may, for example, be similar to the information presentation system 110 discussed previously, and a second information presentation system 110b, which may, for example, be similar to the information presentation system 110 discussed previously. The exemplary information consumption environment 500 is generally a complex information consumption environment involving multiple information presentation systems and multiple co-linked information source devices.

The illustrative information consumption environment 500 also includes a variety of information source devices, such as those discussed previously. A first portion 520 of the information source devices are within the information consumption environment of the first information presentation system 110a and not within the communication environment of the second information presentation system 110b. A second portion 530 of the information source devices are within the information consumption environment of the first information presentation system 110a and the second information presentation system 110b. A third portion 540 of the information source devices are within the information consumption environment of the second information presentation system 110b and not within the information consumption environment of the first information presentation system 110a.

In the illustrated exemplary information consumption environment 500, the user of the first information presentation system 110a is currently consuming information from the PC 521 and television 522 information resource devices that are communicatively linked only to the first information presentation system 110a. The user is not currently consuming the Cellular Phone 523 and DVD Player 524 resources. Since the Cellular Phone 523 and DVD Player 524 resources are only potentially linked with the first information presentation system 110a, the first information presentation system may safely allocate no or low bandwidth to those resources.

Certain information resources may, for example, be able to establish communication links with multiple information presentation systems. For example, the Intercom 531, Telephone 532, Door Camera 533 and Door Bell 534 information resources are capable of linking to either of the illustrated information presentation systems 110a, 110b. Since either information presentation system may be presenting information from these devices to a user, both information presentation systems 110a and 110b may communicate when allocating communication bandwidth to these devices to ensure that communications between one of these devices and an information presentation system will not cause interference with the other information presentation system. Such communications may occur over a communication link between the information presentation systems 110a, 110b, such as illustrated link 550.

For example in the exemplary environment 500, the telephone 532 may communicate information to the first 110a or second 110b information presentation system. Thus, transmissions from the telephone 532 to the second information presentation system 110b may interfere with communications in the environment of the first information consumptions system 110a. Accordingly, if a user of the second information presentation system 110b indicates a desire to consume information from the telephone 532, the second information presentation system 110b may communicate with the first information presentation system 110a to allocate common communication bandwidth to the telephone 532 that will not cause interference in the environment of the first information presentation system 110a.

For example, the information consumptions systems 110a, 110b may maintain a list of common communication bandwidth that is allocated to such common information source devices 530. The information presentation systems 110a, 110b may then consider bandwidth that is currently allocated to such common information source devices 530 when making bandwidth arbitration decisions.

Further, the information presentation systems 110a, 110b may maintain a list of all communication bandwidth currently in use by the other information presentation system. The information presentation systems 110a, 110b may consider the other's bandwidth usage when making bandwidth allocation decisions. For example, if the first information presentation system 110a is utilizing a first communication channel to communicate with an information source device, the second information presentation system 110b may try to avoid using this first communication channel to reduce interference between communication environments.

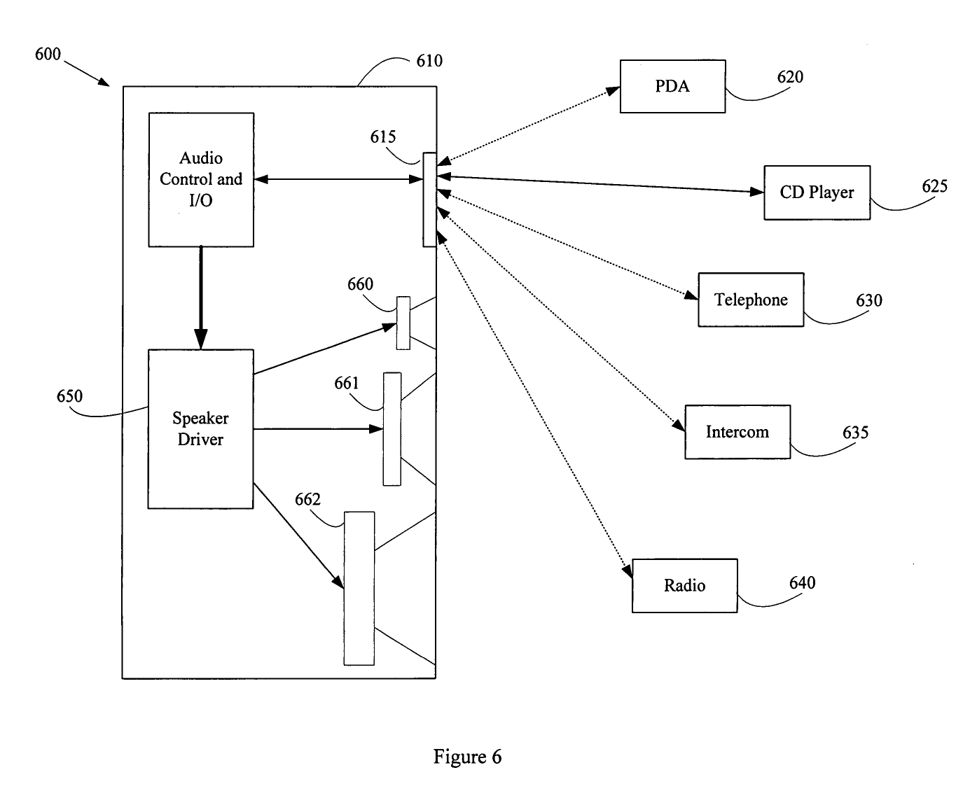

FIG. 6 is a diagram illustrating an exemplary dynamic audio information consumption environment 600 in accordance with various aspects of the present invention. FIG. 6 demonstrates that an information presentation system incorporating various aspects of the present invention need not be limited to a visual display system or audio/visual display system. The exemplary information consumption environment 600 includes an audio information presentation system 610 and various audio information source devices that may provide audio information to the audio information presentation system 610. The various audio information source devices may include, for example and without limitation, a PDA 620, compact disc (CD) player 625, telephone system 630, intercom system 635 and radio system 640.

Each of the audio information source devices may be communicating with or attempting to establish communications with the audio information presentation system 610. The audio information source devices may communicate with the audio information presentation system 610 through a communication port 615. The audio information presentation system 610 may, for example, have a speaker driver 650 and speakers 660-662 for presenting audio information to a user for consumption in human-perceivable form. For example, the audio information presentation system 610 may utilize various audio presentation components to present audio information to a user from the CD player 625, or from the radio 640 and intercom system 635 simultaneously.

The audio information source devices in the environment (or network) 600 may be capable of providing more information simultaneously than a user can consume, or desires to consume, at one time using the audio presentation system 610. Also, the audio information source devices in the environment 600 may be capable of providing more information simultaneously to the audio information presentation system 610 than the audio information presentation system 610 can effectively present to the user. Further, the audio information source devices in the environment 600 may also be capable of communicating more information to the audio information presentation system 610 than the available communication bandwidth between the audio information source devices and the audio information presentation system 610 can carry. Accordingly, intelligently managing such communications and communication resources is desirable.

For example, the audio information source devices may communicate information with the audio information presentation system 610 using one or more wireless standards, such as the Bluetooth, IEEE 802.11 or Ultra Wide Band (UWB) protocols. Such information may also be encoded using various encoding strategies with varying communication bandwidth requirements, such as WAV and MP3 encoding. In such an exemplary wireless environment, the audio information source devices may all communicate information with the audio information presentation system 610 using a common communication band.

Various audio information source devices may communicate information or attempt to communicate information to the audio information presentation system 610 regardless of whether the user is interested in consuming their respective information. In such a situation, limited communication bandwidth, and other communication resources, available for communication between the various audio information source devices and the audio presentation system 610 may be wasted by communicating information in which the user has no interest. Such unnecessarily utilized communication bandwidth may interfere with the user's consumption of desired information.

For example, a user may initially establish an information consumption environment where the user is consuming information from the CD player 625. To provide for this consumption environment, the audio information presentation system 610 may allocate a portion of common communication bandwidth to the communication link between the CD player 625 and the audio information presentation system 610 large enough to accommodate the necessary magnitude of information flow. FIG. 6 illustrates this communication link by the solid line between the CD player 625 and the audio information presentation system 610.

During this exemplary communication, dominated by the communication between the CD player 625 and the audio information presentation system 610, the audio presentation system 610 may maintain relatively low bandwidth communication links between the audio presentation system 610 and the other audio information source devices in the environment 600. FIG. 6 illustrates such communication links as dashed lines between the audio information presentation system 610 and various audio information source devices. The audio information presentation system 610 may, for example, utilize such communication links to maintain a state of readiness between the audio information presentation system 610 and the respective audio information source devices. Accordingly, the environment 600 may be configured to provide desired information to the user for consumption in a timely manner.

Additionally, the audio information presentation system 610 may utilize such relatively low bandwidth communication links to communicate background information between the various audio information source devices and the audio information presentation system 610. Such communications may occur without interfering with higher priority information communications. The audio information presentation system 610 may also utilize such relatively low bandwidth communication links to maintain an accurate list of available audio information source devices.

Continuing with the example, the user may, during consumption of audio information from the CD player 625, desire to momentarily consume information from the intercom system 635 with the radio 640 in the background. If, for example, there is insufficient common communication bandwidth to adequately communicate information from the CD player 625, radio 640 and intercom system 635 to the audio information presentation system 610 simultaneously, then the audio information presentation system 610 may re-allocate portions of the common communication bandwidth from the CD player 625 to the radio 340 and intercom system 635.

As a further illustrative example, a user may initially establish an information consumption environment where the user is consuming audio information from the PDA 620 when the telephone system 630 rings. In response to the ringing telephone system 630, the audio information presentation system 610 may automatically allocate portions of the common communication bandwidth to the telephone system 630 and allocate remaining available portions of the common communication bandwidth to the PDA 620 for presentation in the background.

The audio information presentation system 610 may present indications to the user to inform the user which audio information source devices the audio information presentation system 610 has detected in the environment 600 that have audio information available for user consumption. The audio information presentation system 610 may, for example, present visual indications to the user. The audio information presentation system 610 may include a visual display, or be communicatively coupled to a visual display, on which the audio information presentation system 610 may display textual or graphical indications to the user. The audio information presentation system 610 may provide for user selection of the audio information source device or devices from which the user desires to consume information. The audio information presentation system 610 may then allocate the common communication bandwidth between the audio information presentation system 610 and audio information source devices according to the user's consumption of audio information.

Note that the audio information presentation system 610 illustrated in FIG. 6 is but one example of an audio information presentation system that may provide human-perceivable information to a user for consumption. Accordingly, the scope of various aspects of the present invention should, by no means, be limited by characteristics of the exemplary audio information presentation system 610.

In summary, aspects of the present invention provide a system and method for consumption-based bandwidth arbitration in a dynamic information consumption environment.

While the invention has been described with reference to certain aspects and embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for allocating communication bandwidth between information source devices and an information presentation system, the method comprising:
detecting a plurality of information source devices, each of which is capable of communicating information to a user output device using communication bandwidth in a common communication band;
presenting respective indications of the detected information source devices to a user;
receiving an indication that the user desires to receive information from at least one of the detected information source devices; and
allocating communication bandwidth from the common communication band for communication between the detected plurality of information source devices and the information presentation system based on the detected user selection of at least one of the detected information source devices.

2. The method of claim 1, wherein the bandwidth allocating step comprises allocating at least a portion of the common communication band for communication between the information presentation system and the at least one selected information source device.

3. The method of claim 1, wherein the bandwidth allocating step comprises allocating communication bandwidth from the common communication band to detected information source devices that are not selected by the user.

4. The method of claim 1, wherein the bandwidth allocating step comprises allocating a first portion of the common communication band to a detected information source device that is selected by the user, and allocating a second portion of the common communication band to a detected information source device that is not selected by the user, the second portion being less than the first portion.

5. The method of claim 1, wherein the information source detecting step comprises periodically scanning a communication network to identify information source devices capable of communicating information to the user output device.

6. The method of claim 1, wherein the indication presenting step comprises generating respective graphical indications of the detected information source devices.

7. The method of claim 1, wherein the indication presenting step comprises generating respective textual indications of the detected information source devices.

8. The method of claim 1, wherein the indication receiving step comprises receiving an indication that the user has selected at least one of the presented respective indications of the detected information source devices.

9. The method of claim 1, wherein the indication receiving step comprises receiving the indication automatically when a user-specified event has occurred.

10. The method of claim 1, wherein:
the indication receiving step comprises receiving an indication that the user desires to receive information from a first detected information source device and a second detected information source device; and
the bandwidth allocating step comprises allocating a first portion of the common communication band for communication between the information presentation system and the first detected information source device, and allocating a second portion of the common communication band for communication between the information presentation system and the second detected information source device.

11. The method of claim 10, wherein:
the indication receiving step further comprises receiving an indication that the user has placed a higher priority on consuming information from the first detected information source device than on consuming information from the second detected information source device; and
the bandwidth allocating step further comprises allocating the first and second portions of the common communication band based on the indication of priority.

12. The method of claim 1, wherein the bandwidth allocating step comprises communicating with the at least one selected information source device to determine communication capabilities of the at least one selected information source device.

13. The method of claim 1, wherein the bandwidth allocating step comprises selecting a communication protocol from a plurality of communication protocol alternatives.

14. The method of claim 1, further comprising:
receiving an indication that the user no longer desires to receive information from an information source device; and
de-allocating at least a portion of the common communication band that was allocated to the information source device from which the user no longer desires to receive information.

15. The method of claim 14, further comprising, after receiving the indication that the user no longer desires to receive information from an information source device, re-allocating at least a portion of the common communication band to communication between the detected plurality of information source devices and the information presentation system.

16. A system for allocating communication bandwidth between a plurality of information source devices and an information presentation system, the system comprising:
a communication module;
a source detection module communicatively coupled to the communication module that detects a plurality of information source devices, each of which is capable of communicating information to the information presentation system, and generates a signal indicative of the detected plurality of information source devices;
a consumption detection module that detects a user selection of at least one of the detected information source devices and generates a signal indicative of the at least one selected information source device;
a bandwidth arbitration module communicatively coupled to the consumption detection module that allocates communication bandwidth to the detected plurality of information source devices based on the signal indicative of the at least one selected information source device.

17. The system of claim 16, wherein the source detection module detects the plurality of information source devices by utilizing the communication module to periodically scan a communication network to identify information source devices capable of communicating information to the user output device.

18. The system of claim 16, wherein the signal indicative of the detected plurality of information source devices comprises graphical information indicative of the detected plurality of information source devices.

19. The system of claim 16, wherein the signal indicative of the detected quality of information source devices comprises textual information indicative of the detected plurality of information source devices.

20. The system of claim 16, wherein the consumption detection module detects a user selection of a graphical indication of at least one of the detected information source devices.

21. The system of claim 16, wherein the consumption detection module detects a user selection of a textual indication of at least one of the detected information source devices.

22. The system of claim 16, wherein the consumption detection module detects a user adjustment of the display characteristics of a display window.

23. The system of claim 16, wherein the bandwidth arbitration module allocates communication bandwidth by allocating at least a portion of common communication media bandwidth for communication between the information presentation system and the at least one selected information source device.

24. The system of claim 16, wherein:
the consumption detection module detects a user selection of a first detected information source device and a second detected information source device; and
the bandwidth arbitration module allocates a first portion of common communication media bandwidth for communication between the information presentation system and the first detected information source device, and allocates a second portion of common communication media bandwidth for communication between the information presentation system and the second detected information source device.

25. The system of claim 24, wherein:
the consumption detection module detects an indication that the user has placed a higher priority on consuming information from the first detected information source device than on consuming information from the second detected information source device; and
the bandwidth arbitration module further allocates the first and second portions of common communication media bandwidth based on the indication of priority.

26. The system of claim 16, wherein the bandwidth arbitration module communicates with the at least one selected information source device to determine the communication capabilities of the at least one selected information source device, and utilizes the communication capability determination to determine which communication bandwidth to allocate to the at least one selected information source device.

27. The system of claim 16, wherein the source detection module detects the plurality of information source devices by utilizing the communication module to periodically scan a plurality of communication networks, each communication network having a respective communication protocol, to identify information source devices capable of communicating information to the user output device.

28. The system of claim 16, wherein:
the consumption detection module further detects a user de-selection of an information source device, and
the bandwidth arbitration module re-allocates at least a portion of communication bandwidth previously allocated to the de-selected information source device.
